(19) United States
(12) Patent Application Publication
(10) Pub. No.: US 2006/0088160 A1
(43) Pub. Date: Apr. 27, 2006

(54) Method and apparatus for generating and printing a security stamp with custom logo on an electrophotographic printer

(75) Inventors: Rickey Carter Brown, Bardstown, KY (US); Kevin Eugene Eby, Lexington, KY (US); Cuong Manh Hoang, Lexington, KY (US); David Keith Lane, Stamping Ground, KY (US); Richard Francis Russell, Pittsburgh, PA (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 10/976,293

(22) Filed: Oct. 27, 2004

(51) Int. Cl. G09C 3/08

(52) U.S. Cl. 380/51

(57) ABSTRACT

An improved electrophotographic printer is provided for generating a security stamp in firmware, and printing that security stamp to create documents that have a visible and tactile logo that is automatically printed on each page of a print job. The firmware will automatically create the proper bitmap of the security logo for a page's print resolution and bit depth. Using a color laser printer, the security stamp can be printed using all of the process colors, such as CMYK, which would be rendered and printed at 400% toner coverage. This gives the security stamp a very dark visible appearance and a thick tactile texture. The security stamp can include an area for printing a serial number of the printer, and for printing a time and date stamp.

### TECHNICAL FIELD

The present invention relates generally to image forming equipment and is particularly directed to electrophotographic printers of the type which that use toner to print images on sheets of print media, such as paper. The invention is specifically disclosed as a laser printer that generates a security stamp in the printer's firmware and prints that security stamp on sheet media, to create documents that have a visible and tactile logo that is automatically printed on each page of a print job. The firmware will automatically create the proper bitmap of the security logo for a page's print resolution and bit depth.

If the printer is a color laser printer, then the security stamp can be printed using all of the process colors; if there are four colors (CMYK), then the security stamp can be rendered at 400% coverage, thereby giving the security stamp a very dark visible appearance as well as a rather thick texture that can be easily felt tactilely. If there are three colors (CMY), then the security stamp can be rendered at 300% coverage, in a similar fashion.

The security stamp can include an area for printing a serial number of the printer, and for printing a time and date stamp. The printer's firmware will have its serial number available in memory. The time and date information must be provided to the printer, either from an external source such as a PC, or it can be set into the printer's real time clock. The time information would include the correct time zone where the printer is located.

### BACKGROUND OF THE INVENTION

Conventional color laser printers have had the ability to print a device serial number using a pattern of yellow dots, which provides a rather subtle indication as to which printer was used for printing that particular page. In the future, this serial number could be used as part of security stamp system for documents printed on certain types of printers, such as laser printers manufactured by Lexmark International, Inc. Additional information could be used in such a security stamp system, such as a time and date stamp, similar to information that has been available with fax machines. However, non-fax printers typically do not have time and date information provided to them from a network time protocol server, in which that information is printed as a time or date stamp on a page.

Conventional printers do not typically allow a user-defined logo (e.g., graphic design artwork) to be placed as a security stamp on printed pages, in which the user can update the logo and have the printer automatically size that logo onto the printed page. In such a situation, the user may wish such a security stamp logo to be much more obviously visible than using yellow color dots, as has occurred in previous printers that can print their serial number, for example.

Typical electrophotographic printers (such as laser printers) do not allow 300% or 400% toner coverage for color printers. One reason most printers will not allow either 300% or 400% coverage is that the fuser roller and other components of a laser printing system might be damaged by large areas of very dense toner coverage.

It would be an improvement to allow a user to define a logo as a graphic design bitmap to be downloaded to a printer and have that logo automatically printed on each page as a security stamp. Such a security stamp could be a “blatant” security stamp instead of the previous “serial number” stamps that were rather subtle, by use of yellow dots. It would also be an improvement for the security stamp to be automatically scaled and rotated as a bitmap in the printer's memory, in which these image processing functions occur within a printer without requiring that printer to undergo a reset or a power down procedure.

### SUMMARY OF THE INVENTION

Accordingly, it is an advantage of the present invention to print a user-defined logo on a printed page in composite 300% coverage of three-color toner, or 400% coverage of four-color toner on a color electrophotographic printer.

It is another advantage of the present invention to provide a printer that receives a user-defined logo as a graphic image and automatically positions and scales that logo on each page of a print job, in which the logo can also be printed with the device's serial number, and/or printed with a time stamp and/or a date stamp (e.g., a time/date stamp).

It is yet another advantage of the present invention to provide a printing system, in which a computer wraps a user-defined logo as a graphic image, and sends that logo to a printer as part of a print job, after which the printer will unwrap the logo and automatically position and scale that logo to be printed on each page of a print job, as part of a security stamp.

It is still another advantage of the present invention to provide a printer that will receive a user-defined logo and automatically scale and rotate that logo as a portion of image processing of the printer at the bitmap level, including logos used at different print resolutions and bit depths.

It is still another advantage of the present invention to provide a printer that can receive a user-defined logo from a computer, and later receive an updated logo from the user's computer (at the printer), and then use the updated logo without undergoing a reset or a power-off cycle at the printer.

It is yet a further advantage of the present invention to provide a printer that will automatically search for a logo image file stored in a memory circuit or memory device on the printer, and if found will allocate memory for bitmaps after the logo is rendered, for each color, and for more than one print resolution and bit depth.

It is still a further advantage of the present invention to provide a printer that can print a user-defined logo and automatically position and size that logo for each page of a print job, and also print a device serial number and/or a time and date stamp at positions proximal to the logo, all as part of a security stamp.

Additional advantages and other novel features of the invention will be set forth in part in the description that follows and in part will become apparent to those skilled in the art upon examination of the following or may be learned with the practice of the invention.

To achieve the foregoing and other advantages, and in accordance with one aspect of the present invention, a method for printing a security stamp using an image forming apparatus is provided, in which the method comprises the following steps: (a) providing an image forming apparatus having a memory circuit for storage of data, a communications port, and a processing circuit; (b) storing at least one security stamp bitmap in the memory circuit; (c) upon receiving a print job through the communications port, rendering a page of the print job, and selecting one of the at least one security stamp bitmap; and (d) printing the page with the selected one of the at least one security stamp bitmap.

In accordance with another aspect of the present invention, a method for printing a security stamp using an image forming apparatus is provided, in which the method comprises the following steps: (a) providing an image forming apparatus having a memory circuit for storage of data, a communications port, and a processing circuit; (b) receiving security stamp image information through the communications port, and storing the security stamp image information in the memory circuit; (c) generating at least one security stamp bitmap representation of the security stamp image information; (d) receiving a print job through the communications port, rendering a page of the print job, and selecting an appropriate one of the at least one security stamp bitmap based upon at least one of the page's (i) print resolution, and (ii) bit depth; and (e) printing the page with the selected one of the at least one security stamp bitmap.

In accordance with yet another aspect of the present invention, an image forming apparatus is provided, which comprises: a memory circuit for storage of data; a communications port that is effectively connected to the memory circuit and which can be effectively connected to at least one external device, and capable of transferring data therebetween; a processing circuit that is configured to control the flow of data between the memory circuit and the communications port; and a print engine that produces a physical output upon a print media under control of the processing circuit; wherein the processing circuit is configured: (a) to store at least one security stamp bitmap in the memory circuit; (b) upon receiving a print job through the communications port, to render a page of the print job; (c) to select one of the at least one security stamp bitmap; and (d) using the print engine, to print the page with the selected one of the at least one security stamp bitmap.

Still other advantages of the present invention will become apparent to those skilled in this art from the following description and drawings wherein there is described and shown a preferred embodiment of this invention in one of the best modes contemplated for carrying out the invention. As will be realized, the invention is capable of other different embodiments, and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification illustrate several aspects of the present invention, and together with the description and claims serve to explain the principles of the invention. In the drawings:

FIG. 1 is a hardware block diagram of some of the major components of a printer, as constructed according to the present invention.

FIG. 2 is a diagrammatic view of a portion of a page of sheet media that shows the areas where a security stamp of the present invention is to be placed.

FIG. 3 is a flow chart showing some of the important logic steps used in printing one or more pages of a document that will contain a security stamp, as according to the principles of the present invention.

FIG. 4 is a flow chart showing the steps of a routine executed on a personal computer or other external computing device that sends a new logo to a printer, such as the printer of FIG. 1.

FIG. 5 is a flow chart showing the steps of a routine executed on a printer to update the logo information in that printer, such as the printer of FIG. 1.

### DETAILED DESCRIPTION OF THE PREFERRED EMBODIMENT

Reference will now be made in detail to the present preferred embodiment of the invention, an example of which is illustrated in the accompanying drawings, wherein like numerals indicate the same elements throughout the views.

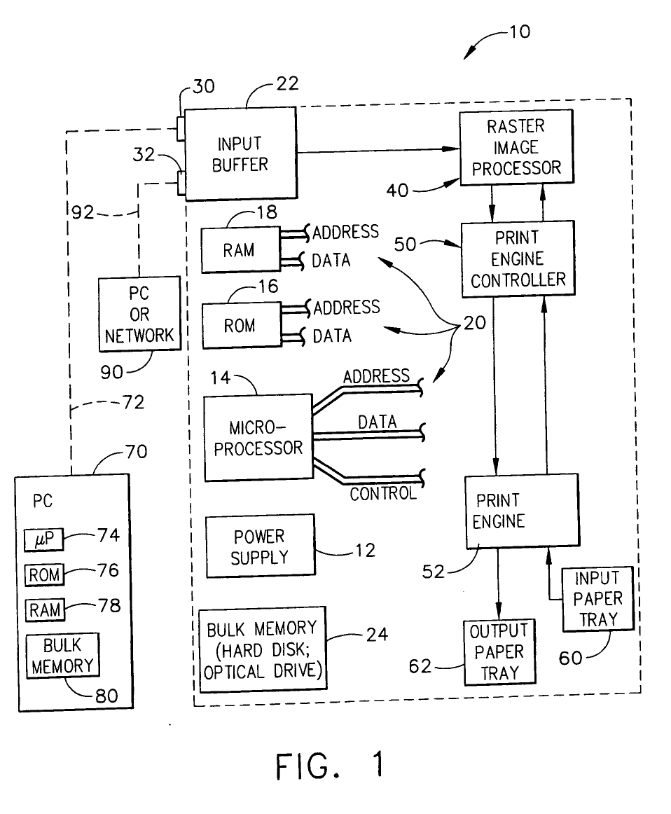

Referring now to FIG. 1, a laser printer or other type of electrophotographic (EP) printer is depicted, generally designated by the reference numeral 10, and FIG. 1 is a hardware block diagram generally showing some of the main components of the electrophotographic (EP) printer. Printer 10 contains an electrical power supply 12, which typically receives AC voltage and outputs one or more DC voltages. The printer 10 also contains some type of processing circuit, such as a microprocessor or microcontroller 14, which typically has at least one address bus, one data bus, and perhaps one control bus or set of control signal lines, all generally designated by the reference numeral 20.

Such an EP or laser printer 10 would also contain memory elements, such as read only memory (ROM) 16 and random access memory (RAM) 18, which also would typically be in communication with an address bus and data bus, and typically connected through the buses 20 to the microprocessor or microcontroller 14.

Most printers receive print jobs from an external source, and in printer 10 there typically would be an input buffer 22 to receive print data, usually through at least one input port, such as the ports 30 and 32. In modern printers, a typical input port could be a USB port or a network ETHERNET port, but also other types of ports can be used, such as parallel ports and serial ports. The input buffer 22 can be part of the overall system RAM 18, or it can be a separate set of memory elements or data registers, if desired.

In many modern EP printers, additional memory devices are included, such as some type of bulk memory device, as indicated at the reference numeral 24. The bulk memory device 24 could comprise a hard disk drive, or perhaps an optical drive that has read/write capabilities.

When a print job arrives at the input buffer 22, it is passed to a raster image processor (RIP) stage, at reference numeral 40. The print job is typically divided into individual pages, and any rasterizing that may need to be performed will occur at this RIP stage 40. Once the print job has been divided into individual bitmaps that represent pages, the print data is then sent to a print engine controller, at reference numeral 50. It will be understood that, in many modern EP printers, an entire page of bitmap data is not necessarily available in its final rasterized form at the moment when the first scanline of bitmap data is sent to the print engine controller for that same page.

The print engine controller 50 controls all of the mechanical devices of a standard EP or laser print engine 52. In most sheet printers, there is at least one input paper tray, such as a paper tray 60 in FIG. 1. When needed, the print engine 52 actuates the input paper tray 60, and causes it to send a sheet of print media to the print engine 52, whereupon it is printed with toner. When the print engine 52 is finished with this particular sheet, the printed sheet is sent to an output paper tray, generally designated by the reference numeral 62 on FIG. 1.

In many conventional EP printers, there is a one ASIC for controlling the print raster imaging process and a separate (second) ASIC for controlling the print engine. In many newer conventional printers, the ASICs have become powerful enough that all of the elements that make up the rasterizer (image processor) and the print engine controller can be placed into a single ASIC package. The processing circuit and memory circuit elements may, or may not, be resident on the ASIC. The exact hardware configuration of these circuit components is not of critical importance in the present invention.

Now that the standard components of a typical EP printer have been introduced above, printer operations can be described. The printer 10 will receive print jobs from some external source at the input ports 30 and 32. For example, a personal computer (PC) generally designated by the reference numeral 70 can send print jobs over a cable (or other form of communications link) 72 to the input port 30. Furthermore, a second PC 90 can send print jobs over a communications link 92 to the other input port 32, if desired. Such a PC 90 can also be connected over a network, if desired. In fact, both PCs on FIG. 1 could be connected through networks, if desired.

The personal computer 70 would typically include some type of processing device, such as a microprocessor integrated circuit 74. PC 70 would also contain read only memory (ROM) 76, random access memory (RAM) 78, and typically would also contain some type of bulk memory device 80. The bulk memory device could be some type of hard disk drive or perhaps an optical drive that has read/write capabilities.

In the present invention, a blatant security stamp can be printed on each page of a print job, in which the security stamp includes a user-defined logo as a custom graphic design, which is downloaded from the user's computer to the printer. The security stamp will be automatically printed at a predetermined location on each page of a document produced by the printer, such as in the lower right-hand corner of each page. As an option, the printer's serial number can be printed as part of the security stamp near the logo, and also if desired a date/time stamp can be printed near the logo as part of the security stamp.

In the present invention, the security stamp is generated by the printer firmware, so it requires no changes to any printer drivers, and all pages produced by the printer can include the security stamp. Such a security stamp can be utilized on both color printers and monochrome printers, and in the case of color laser printers, the logo can be rendered and printed in all of the process colors, if desired. For example, in a CMY printer, all three of the process colors can be printed with the same bitmap that makes up the logo, which will provide 300% toner coverage for this image that makes up the logo design. This will create the blatant security stamp that is desired by the user, which will be both quite dark and visible, and also will be rather thick and have a texture that can be easily felt tactilely. This 300% coverage is also referred to as “composite black.” In addition, in a four-color laser printer (CMYK), the logo can be printed in 400% toner coverage, if desired. This will create an even darker and thicker texture security stamp.

In the present invention, a WINDOWS™ application is provided by the printer manufacturer to be run on the user's PC, so the user can easily update the custom bitmap of the logo, when desired. This custom bitmap will then be downloaded to the printer, and the printer's firmware will automatically scale and position the custom bitmap used for the logo. This custom logo information can be stored on a specified memory device, such as a hard disk drive within the printer; the logo can then be retrieved by the printer and used without a power cycle (or a “warm” reset) of the printer. The process of sending the custom logo from the PC to the printer can utilize a POSTSCRIPT® print job that contains the logo bitmap information, using the POSTSCRIPT job as a wrapper that sends the cached logo to the printer. A custom POSTSCRIPT operator is created to notify the rendering logic of the printer that the incoming POSTSCRIPT job is a page that contains a security stamp logo. The printer's rendering logic receives this POSTSCRIPT job and notes the resolution, bit depth, and orientation before extracting the logo, and then stores the logo in an array and discards the original page of this POSTSCRIPT job. The logo can be rendered at several print resolutions and bit depths, if desired, for the various types of print jobs that will later be executed by the printer.

In situations using color printers, the logo can be printed in composite black text at 300% coverage (as noted above), or possibly at 400% toner coverage for composite black text as well as actual black toner (as noted above). The result of this 300% or 400% coverage is a difference in color and texture that is difficult to duplicate. It should be noted that most color printers do not permit a user to render images at 300% or higher coverage, because such images can only be reliably fused in small regions. In the present invention, the security stamp would typically be limited to a certain predetermined maximum area on a printed page, and thus the 300% or 400% coverage can be used without damage to the fuser or other printer components.

The use of a time and date stamp in various languages also is a feature of the present invention. It is fairly easy to render this information in POSTSCRIPT print jobs, because the emulator can be extended to access such information and place it on a page. However, such a task becomes more difficult with languages such as PCL, XL, and PPDS (parallel port data stream) that send print jobs from a PC. In the present invention, the security stamp will be rendered correctly every time because it is rendered at a level below the language emulators and graphics engine. The printer's executing software or firmware renders characters without a font management system, and will scale its own images. The time and date stamp information can be obtained from a network time protocol server, and that information can be rendered on each page proximal to the logo image. The printer's serial number can also be rendered and placed proximal to the logo's image, at a proper print resolution and bit depth.

It would be preferable for there to be no indication of this security stamp function on the printer's op-panel, and also for there to be no means for the user to otherwise disable or suppress the operation of the security stamp through the op-panel. Once the security stamp software is entered into a printer's operating firmware, the security stamp will be automatically printed for each page produced by that printer. This invention can be flashed as a software download to appropriate types of printers, such as Lexmark Models C912 or T632 laser printers.

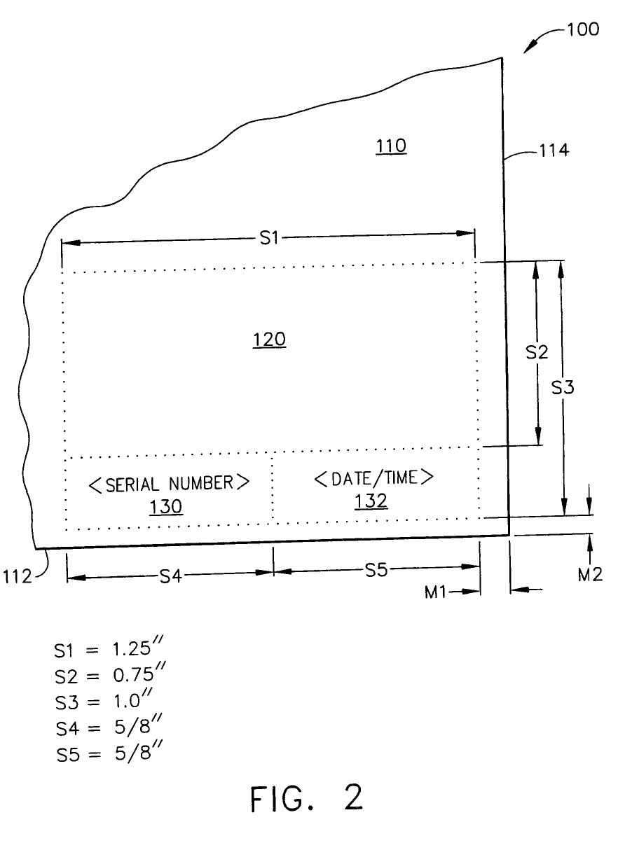

Referring now to FIG. 2, a sheet of print media is generally designated by the reference numeral 100, and includes a top planar surface at 110. In FIG. 2, a portion of the sheet 100 is illustrated at its lower right-hand corner, and exhibits a bottom edge 112, and a right-hand edge 114.

In the present invention, the “security stamp” can be in the form of a “logo” or other type of graphic design, if desired. The area 120 on FIG. 2 indicates a location where such a security stamp/logo is to be placed on the printed sheet 100. If desired, a serial number of the printing device can also be printed within an area at 130, and also a date/time stamp can be printed within an area at 132, if desired.

Some exemplary dimensions for the logo and other printed materials that make up the security stamp are as follows: a dimension S1 indicates the overall maximum width of the security stamp, and could have an exemplary width of 1.25 inches. A dimension S3 indicates the overall maximum height of the entire security stamp area, and could have an exemplary dimension of 1.0 inches. Within this overall set of dimensions S1×S3, the logo in the area 120 could have maximum dimensions S1×S2, in which an exemplary dimension for the height S2 could be 0.75 inches.

The area 130 is reserved for a serial number of the printing device, if desired, and would have a maximum width dimension indicated at S4, which could be about ⅝ inches maximum. A similar size area S5 is reserved for the date/time information in the area 132, and has a maximum width dimension at S5, which also could be about ⅝ inches, maximum. This would make the height and width dimensions for both the areas 130 and 132 at about ⅝ inches wide by ¼ inches in height. It will be understood that all of the dimensions S1-S5 can be easily modified, without departing from the principles of the present invention. Moreover, the ratios of these individual dimensions could easily by altered without departing from the principles of the present invention.

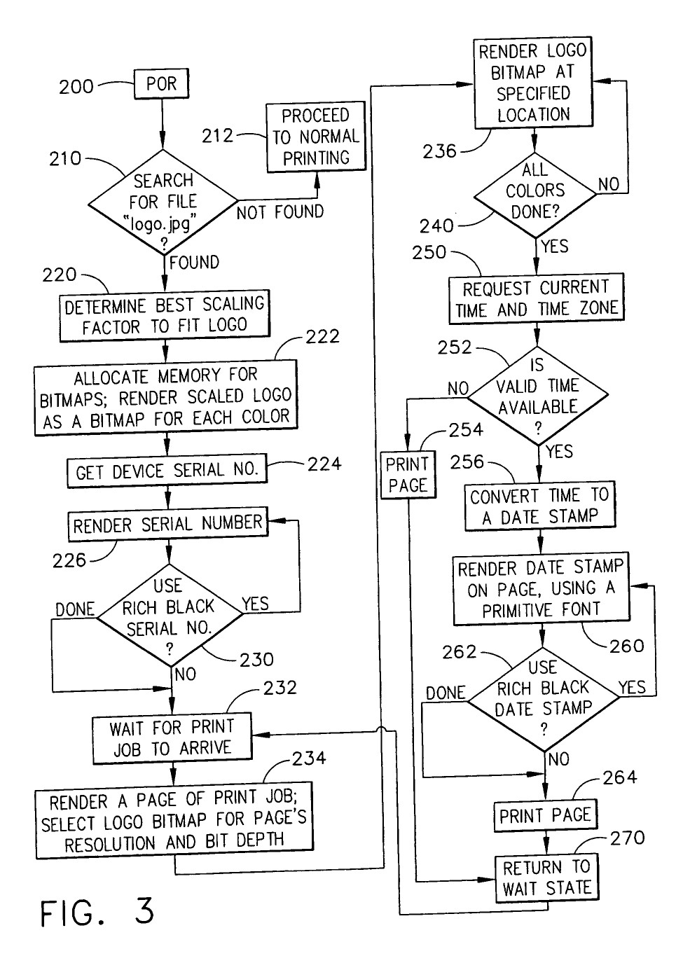

Referring now to FIG. 3, a flow chart of some of the operations of the printer 10 of the present invention are described. An initial step 200 indicates a procedure in which the printing device undergoes a power on reset operation, which typically initializes the EP printer 10. Using the flow chart routine of the present invention, a decision step 210 now searches for a file (or other data storage area) that contains a logo (or other design artwork) that is to be used as part of the security stamp of the present invention. In one form of the present invention, a file named “logojpg” would be used to contain the logo graphic design information. In step 210, this filename would be searched for all storage devices that might contain the logo used for the security stamp of the present invention. If this logo is found on one of the predetermined storage devices, then the logic flow travels to a step 220. On the other hand, if the appropriate logo file is not found on any of the predetermined storage devices, the logic flow is directed to a step 212, and the printer proceeds to its other “normal” printing operations, without any of the security stamp features of the present invention.

In step 220, the system determines what the best scaling factor should be to fit the logo information into the appropriate fixed space (e.g., the area 120 on FIG. 2) without distortion. After that has been determined, a step 222 allocates appropriate memory for storing the security stamp logo bitmaps, at each supported resolution and bit depth. (It will be understood that each EP printer or laser printer that exists as a product will support only certain resolutions and bit depth parameters.)

Step 222 also renders (e.g., rasterizes) the scaled logo as a bitmap for each of the printer's supported resolution and bit depth parameters. Step 222 will do this for each color plane that is supported by the printing device. In other words, if printer 10 is a four-color laser printer, for example, then step 222 will render the scaled logo as a bitmap four different times, once for each of these four possible color planes. Of course, it is possible that the logo bitmap will not use all of the possible color planes that are available in a particular printing device.

A step 224 now obtains the serial number of the printing device 10. This assumes that printer 10 is a substantially sophisticated device, such that its operating system can determine what the serial number is, either as numeric values, or perhaps as alphanumeric values. This information would be used to print the serial number in the space 130 on FIG. 2, if desired. Assuming that this indeed is desired, a step 226 will render the serial number of the printing device, so that it can be printed as part of the bitmap of a page that will be output by printer 10.

A decision step 230 now determines whether or not a “rich black” serial number is desired for the pages that are to be printed. If the answer is YES, then the step 226 is repeated for each of the printing device's color planes. In general, this means that all four color planes (i.e., in a four-color printing device) will be used to print the serial number in space 130, and each of the color planes will have identical bitmap information for this serial number. In that situation, the overall toner that is applied to the page for printing the serial number will end up being substantially thick to the touch, and will also be quite visible as a dark black number (or other alphanumeric data) on the page. This, of course, is the desired result when using the security stamp procedures of the present invention.

If a rich black serial number is not desired, then the logic flow can leave decision step 230 after a single rendering of the serial number, if desired, in which case the logic flow is directed to a step 232. On the other hand, if a rich black serial number is desired, the logic flow will travel back to step 226 as many times as it takes to render the serial number in all of the device color planes. When all color planes are finished, the logic flow travels out the DONE output from step 230, and arrives at step 232.

At step 232, the printing device now waits for a new print job to arrive from one of the external sources, such as the PC 70. Of course, other printer operations can take place while this flow chart is at the “wait” state at step 232, assuming a multi-tasking processor. When a new print job does occur, a step 234 renders a page of the print job, and selects the logo bitmap that matches the resolution and bit depth of this particular page of print data. In general, this will occur for each new page of the print job.

A step 236 will now render the logo bitmap at a specified location on the page that is being printed. In the example of FIG. 2, the specified location is the area 120. A decision step 240 determines whether or not the particular page being printed supports color, and if so it determines if all colors have been rendered for the logo bitmap. If not, then step 236 is repeated until all colors have been rendered for the logo bitmap. Once that has occurred, the logic flow travels to a step 250.

At step 250, the printing routine of the present invention requests the current time and time zone that the printing device is located in. A decision step 252 determines whether or not a valid time is available from either the printing device itself, or from information sent by one of the external sources, such as PC 70. If a valid time is not available, then a step 254 prints the page without any time/date stamp being printed in the area 132 of FIG. 2. On the other hand, if a valid time and time zone are both available, then a step 256 converts the time/date information to a “date stamp” that will be printed in the area 132 on the surface 110 of the sheet media 100.

In greater detail, a step 260 renders the time and date stamp for this particular page, using a primitive font. In this manner, the time and date information can be received by printer 10 in real time, then rendered in real time based on changeable data that was not already stored in the printer, and also not already stored in a file on one of the external devices, such as PC 70.

If the page supports color, then a decision step 262 determines whether or not a “rich black” date stamp is desired, and if so, repeats the rendering step 260 multiple times, once for each color plane of this page (that of course must also be supported by the printer itself). If only a single color plane is to be used for the date stamp, then the logic flow travels immediately to a step 264; or if all supported color planes have been rendered for the date stamp at step 260, then the logic flow travels out the DONE result from step 262, also arriving at step 264.

The page is now printed at step 264. Once that has occurred, a step 270 returns this routine to the wait state 232, where this routine of printer 10 is essentially idling, while the logic flow waits for the next print job to arrive.

Part of the present invention is an executable routine that allows a new logo used with the security stamp to be sent to a printer that will be used to print documents containing this security stamp logo. Starting at a step 300, the new logo information is stored on an external device, such as a personal computer. This new logo is saved typically as a JPEG file, typically in a <*.jpg> file format. A computer program stored on the PC being used for this security stamp procedure will now be executed at a step 302. This typically would be a computer program supplied by the printer manufacturer, such as Lexmark International, Inc. Once the security stamp program is being executed, a step 304 is used to embed the JPEG data in a POSTSCRIPT® job, and a step 306 now sends that POSTSCRIPT job to a specified printer. Of course, if the PC running the Lexmark security stamp computer program is connected to only a single PC, then that will be the “specified printer” of step 306. On the other hand, if the PC is connected to a network, then there could be more than one possible printer that will receive the logo information to be used in the security stamp.

Another part of the present invention includes an executable routine within the printing device itself that allows the logo of the security stamp to be updated. Such an update can occur in real time, and preferably will be executed in the printer without causing or requiring the printer to undergo a software reset or a “hard” reset before the update becomes effective.

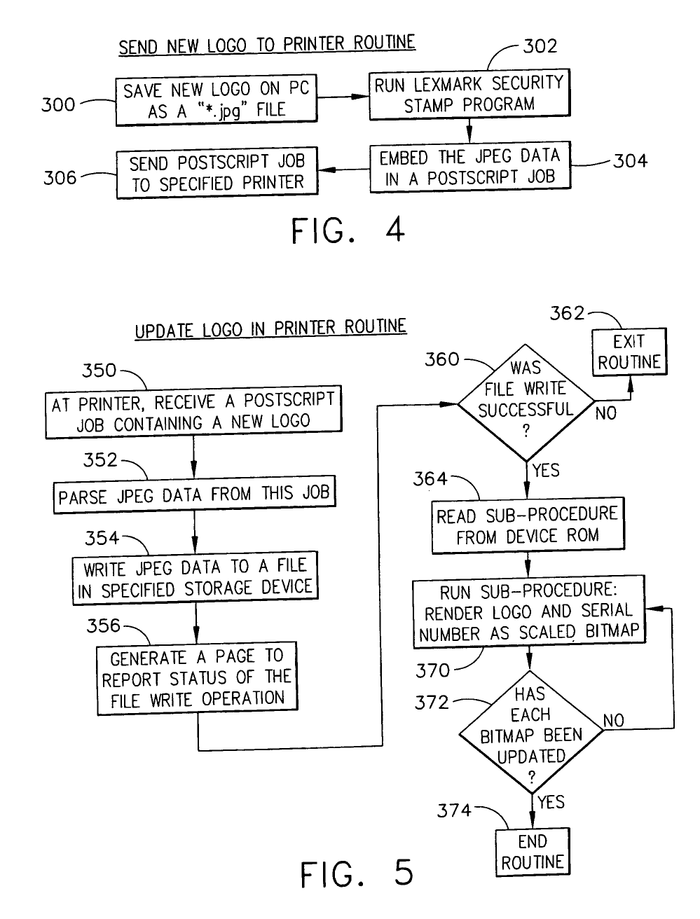

Referring now to FIG. 5, a step 350 is executed in the printer 10 to receive a POSTSCRIPT job containing a new logo. This new logo is being sent by an external device, such as a PC, using a computer program that executes a function such as the step 306 on FIG. 4. A step 352 now parses the JPEG data from this POSTSCRIPT job. The JPEG data is now written to a file in a specified storage device, using a step 354. The specified storage device could be RAM 18 of the printer 10, or it could be a non-volatile memory device, such as a bulk memory device 24 of printer 10. Furthermore, it could be some other type of non-volatile memory device, such as EEPROM or NVRAM (not shown on FIG. 1).

A step 356 now generates a page to report the status of the file write operation that occurred in step 354. This typically would be a printed page that is output from the print engine 52 of printer 10. Alternatively, this status report of step 356 could be sent electronically to an external device, such as to a PC 70 or a network 90. A decision step 360 now determines whether or not the file write operation was successful. If not, this logo update routine is exited at a step 362.

If the file write operation was successful, as determined by step 360, then a step 364 reads a sub-procedure from the device ROM, in a preferred mode of the present invention, such as the ROM 16 of printer 10. If desired, another type of memory could be used besides pure read only memory. This sub-procedure will now be executed at a step 370, and will render the logo and serial number for the security stamp, as scaled bitmaps. These scaled bitmaps will be rendered for each supported resolution and bit depth that is used by the particular printer that is being used to print pages with a security stamp, in a preferred mode of the present invention.

A decision step 372 now determines whether or not each appropriate bitmap has been updated. If not, then step 370 is repeated to render the logo and serial number as a scaled bitmap for a different resolution and bit depth. Once all of the appropriate bitmaps for the logo and serial number have been updated, then the end of this update logo routine is reached, at a step 374.

By use of the principles of the present invention, the security stamp logo and serial number of the printing device can be rendered and stored as scaled bitmaps in real time, without requiring a reset of the printing device itself before these “new” bitmaps become effective. This is possible by using a sub-procedure that is contained in one of the memory devices of the printer 10, such as the ROM 16 memory device. When called to provide a bitmap for the security stamp logo and serial number information, these bitmaps will be retrieved from their appropriate stored locations in memory, and can then be printed in the appropriate locations on every page of a document that is being printed by the print engine 52. In this manner, a clearly visible and tactile security stamp will be printed, perhaps with a date stamp as well.

It will be understood that the term “print media” herein refers to a sheet or roll of material that has toner or some other “printable” material applied thereto by a print engine, such as that found in a laser printer, or other type of electrophotographic printer. Alternatively, the print media represents a sheet or roll of material that has ink or some other “printable” material applied thereto by a print engine or printhead, such as that found in an ink jet printer, or which is applied by another type of printing apparatus that projects a solid or liquified substance of one or more colors from nozzles or the like onto the sheet or roll of material. Print media is sometimes referred to as “print medium,” and both terms have the same meaning with regard to the present invention, although the term print media is typically used in this patent document. Print media can represent a sheet or roll of plain paper, bond paper, transparent film (often used to make overhead slides, for example), or any other type of printable sheet or roll material.

It will also be understood that the logical operations described in relation to the flow charts of FIGS. 3-5 can be implemented using sequential logic, such as by using microprocessor technology, or using a logic state machine, or perhaps by discrete logic; it even could be implemented using parallel processors. One preferred embodiment may use a microprocessor or microcontroller (e.g., microprocessor 14) to execute software instructions that are stored in memory cells within an ASIC. In fact, the entire microprocessor 14 along with dynamic RAM and executable ROM may be contained within a single ASIC, in a preferred mode of the present invention. Of course, other types of circuitry could be used to implement these logical operations depicted in the drawings without departing from the principles of the present invention.

It will be further understood that the precise logical operations depicted in the flow charts of FIGS. 3-5, and discussed above, could be somewhat modified to perform similar, although not exact, functions without departing from the principles of the present invention. The exact nature of some of the decision steps and other commands in these flow charts are directed toward specific future models of electrophotographic printer systems (those involving Lexmark color laser printers, for example), possibly with networks, and similar, but somewhat different, steps would be taken for use with other types or manufacturers of printing systems in many instances, with the overall inventive results being the same.

All documents cited in the Detailed Description of the Invention are, in relevant part, incorporated herein by reference; the citation of any document is not to be construed as an admission that it is prior art with respect to the present invention.

The foregoing description of a preferred embodiment of the invention has been presented for purposes of illustration and description. It is not intended to be exhaustive or to limit the invention to the precise form disclosed. Any examples described or illustrated herein are intended as non-limiting examples, and many modifications or variations of the examples, or of the preferred embodiment(s), are possible in light of the above teachings, without departing from the spirit and scope of the present invention. The embodiment(s) was chosen and described in order to illustrate the principles of the invention and its practical application to thereby enable one of ordinary skill in the art to utilize the invention in various embodiments and with various modifications as are suited to particular uses contemplated. It is intended to cover in the appended claims all such changes and modifications that are within the scope of this invention.

1. A method for printing a security stamp using an image forming apparatus, said method comprising:
(a) providing an image forming apparatus having a memory circuit for storage of data, a communications port, and a processing circuit;
(b) storing at least one security stamp bitmap in said memory circuit;
(c) upon receiving a print job through said communications port, rendering a page of said print job, and selecting one of said at least one security stamp bitmap; and
(d) printing said page with the selected one of said at least one security stamp bitmap.

2. The method as recited in claim 1, wherein said selected one of said at least one security stamp bitmap corresponds to at least one of (i) a print resolution and (ii) a bit depth of said page.

3. The method as recited in claim 1, wherein said image forming apparatus comprises a color electrophotographic printer; and further comprising the steps of: (e) rendering said selected one of said at least one security stamp bitmap in at least two colors; (f) printing said selected one of said at least one security stamp bitmap in a first of said at least two colors at a predetermined location; and (g) printing said selected one of said at least one security stamp bitmap in at least a second of said at least two colors at the same predetermined location, thereby creating a dark and tactile printed security stamp on said page.

4. The method as recited in claim 3, wherein said at least two colors comprises four different colors, and the step of printing said selected one of said at least one security stamp bitmap at the same predetermined location comprises printing all four colors, thereby printing said at least one security stamp bitmap at 400% toner coverage.

5. The method as recited in claim 1, further comprising the steps of: (e) determining identifying information relating to said image forming apparatus, and (f) printing said identifying information upon said page at a predetermined location proximal to said at least one security stamp bitmap.

6. The method as recited in claim 5, further comprising the step of: (g) automatically reading said identifying information as a serial number of said image forming apparatus.

7. The method as recited in claim 1, further comprising the steps of: (e) determining time and date information, and (f) printing said time and date information upon said page at a predetermined location proximal to said at least one security stamp bitmap.

8. The method as recited in claim 7, further comprising the step of: (g) determining a correct time zone in which said image forming apparatus is located.

9. A method for printing a security stamp using an image forming apparatus, said method comprising:
(a) providing an image forming apparatus having a memory circuit for storage of data, a communications port, and a processing circuit;
(b) receiving security stamp image information through said communications port, and storing said security stamp image information in said memory circuit;
(c) generating at least one security stamp bitmap representation of said security stamp image information;
(d) receiving a print job through said communications port, rendering a page of said print job, and selecting an appropriate one of said at least one security stamp bitmap based upon at least one of said page's (i) print resolution, and (ii) bit depth; and
(e) printing said page with the selected one of said at least one security stamp bitmap.

10. The method as recited in claim 9, further comprising the steps of: (f) determining identifying information relating to said image forming apparatus, and (g) printing said identifying information upon said page at a predetermined location proximal to said at least one security stamp bitmap.

11. The method as recited in claim 9, further comprising the steps of: (f) determining time and date information, and (g) printing said time and date information upon said page at a predetermined location proximal to said at least one security stamp bitmap.

12. The method as recited in claim 11, further comprising the step of: (h) determining a correct time zone in which said image forming apparatus is located.

13. The method as recited in claim 9, further comprising the steps of: (f) providing an external computer having a second memory circuit for storage of data, a second communications port, and a second processing circuit, wherein said second communications port is in communication with the first communications port of said image forming apparatus; (g) at said external computer: generating a user-defined logo, embedding said user-defined logo in a predetermined type of print job, and sending said predetermined type of print job to said image forming apparatus; (h) at said image forming apparatus: receiving said predetermined type of print job, parsing said print job to determine said user-defined logo, storing said user-defined logo in the first memory circuit of said image forming apparatus, and thereafter using said user-defined logo for said security stamp image information.

14. The method as recited in claim 13, further comprising the step of: upon the step of storing the user-defined logo in said first memory circuit: (i) reporting a status of the storing operation to said external computer.

15. The method as recited in claim 13, further comprising the steps of: upon the step of storing the user-defined logo in said first memory circuit: (i) rendering said user-defined logo as a scaled bitmap for at least one print resolution and bit depth; and (j) rendering a serial number, if available, as a scaled bitmap for at least one print resolution and bit depth.

16. An image forming apparatus, comprising:
a memory circuit for storage of data; a communications port that is effectively connected to said memory circuit and which can be effectively connected to at least one external device, and capable of transferring data therebetween; a processing circuit that is configured to control the flow of data between said memory circuit and said communications port; and a print engine that produces a physical output upon a print media under control of said processing circuit;
wherein said processing circuit is configured: (a) to store at least one security stamp bitmap in said memory circuit; (b) upon receiving a print job through said communications port, to render a page of said print job; (c) to select one of said at least one security stamp bitmap; and (d) using said print engine, to print said page with the selected one of said at least one security stamp bitmap.

17. The image forming apparatus as recited in claim 16, wherein said selected one of said at least one security stamp bitmap corresponds to at least one of: (i) a print resolution, and (ii) a bit depth of said page.

18. The image forming apparatus as recited in claim 16, wherein said image forming apparatus comprises a color electrophotographic printer; and wherein said processing circuit is further configured: (e) to render said selected one of said at least one security stamp bitmap in at least two colors; (f) using said print engine, to print said selected one of said at least one security stamp bitmap in a first of said at least two colors at a predetermined location; and (g) using said print engine, to print said selected one of said at least one security stamp bitmap in at least a second of said at least two colors at the same predetermined location, thereby creating a dark and tactile printed security stamp on said page.

19. The image forming apparatus as recited in claim 18, wherein said at least two colors comprises four different colors, and wherein the selected one of said at least one security stamp bitmap uses all four colors, thereby producing said at least one security stamp bitmap at 400% toner coverage.

20. The image forming apparatus as recited in claim 16, wherein said processing circuit is further configured: (e) to determine identifying information relating to said image forming apparatus, and (f) using said print engine, to print said identifying information upon said page at a predetermined location proximal to said at least one security stamp bitmap.

21. The image forming apparatus as recited in claim 20, wherein said processing circuit is further configured: (g) to automatically read said identifying information as a serial number of said image forming apparatus.

22. The image forming apparatus as recited in claim 16, wherein said processing circuit is further configured: (e) to determine time and date information, and (f) using said print engine, to print said time and date information upon said page at a predetermined location proximal to said at least one security stamp bitmap.

23. The image forming apparatus as recited in claim 22, wherein said processing circuit is further configured: (g) to determine a correct time zone in which said image forming apparatus is located.

24. The image forming apparatus as recited in claim 16, further comprising: an external computer that includes a second memory circuit for storage of data, a second communications port, and a second processing circuit, wherein said second communications port is in communication with the first communications port of said image forming apparatus;
wherein said processing circuit of said image forming apparatus is further configured: (e) to receive security stamp image information through said communications port; (f) to store said security stamp image information in said memory circuit of said image forming apparatus; and (g) to generate at least one security stamp bitmap representation of said security stamp image information;

25. The image forming apparatus as recited in claim 24,
wherein said second processing circuit is configured: to generate a user-defined logo, embed said user-defined logo in a predetermined type of print job, and send said predetermined type of print job to said image forming apparatus through said second communications port; and
wherein said processing circuit of said image forming apparatus is further configured: to receive said predetermined type of print job, parse said print job to determine said user-defined logo, store said user-defined logo in the first memory circuit of said image forming apparatus, and thereafter use said user-defined logo for said security stamp image information.

26. The image forming apparatus as recited in claim 25, wherein, after storing the user-defined logo in said first memory circuit, said processing circuit of said image forming apparatus is further configured: to report a status of the storing operation to said external computer, through said first communications port.

27. The image forming apparatus as recited in claim 25, wherein, after storing the user-defined logo in said first memory circuit, said processing circuit of said image forming apparatus is further configured: to render said user-defined logo as a scaled bitmap for at least one print resolution and bit depth; and to render a serial number, if available, as a scaled bitmap for at least one print resolution and bit depth.

28. The image forming apparatus as recited in claim 27, wherein said processing circuit is further configured to render said user-defined logo as a scaled bitmap without undergoing a reset of said image forming apparatus.
